(19) United States
(12) Patent Application Publication
(10) Pub. No.: US 2010/0285852 A1
(43) Pub. Date: Nov. 11, 2010

(54) SLIDEABLE HINGE MOBILE COMMUNICATIONS DEVICE

(75) Inventor: Shawn Stephenson, Raleigh, NC (US)

Correspondence Address: MOORE AND VAN ALLEN PLLC FOR SEMC, P.O. BOX 13706, 430 DAVIS DRIVE, SUITE 500, RESEARCH TRIANGLE PARK, NC, 27709, US

(73) Assignee: SONY ERICSSON MOBILE COMMUNICATIONS AB, LUND (SE)

(21) Appl. No.: 12/463,063

(22) Filed: May 8, 2009

(51) Int. Cl. H04M 1/00

(52) U.S. Cl. 455/575.4

(57) ABSTRACT

A mobile device, such as a mobile phone, includes an upper housing, a lower housing and a slideable hinge that slideably connects the upper housing with the lower housing. The slideable hinge is configured to allow the upper housing to slide along a straight line with the lower housing and to allow the upper housing to pivot relative to the lower housing. In one embodiment, the slideable hinge module may be mounted to a display of a mobile phone to allow for sliding and rotation of the display relative to the lower housing.

### FIELD

The present invention relates to mobile devices, and more particularly to mobile device with a slideable hinge.

### BACKGROUND

Currently the movement and position of a display of a mobile communications device is limited creating a somewhat negative experience for a user. Additionally, the parts required for movement of current mobile communications devices necessitates that mobile communications devices have greater thicknesses than mobile communications devices lacking movement.

It is, thus, desired to provide a mobile communications device that allows movement and position of the display. It is also desired to minimize the thickness of the mobile communications device and, thus, minimizing material costs and improving the design and weight of the mobile communications device.

### SUMMARY OF THE INVENTION

In accordance with an embodiment of the present invention, a mobile device includes an upper housing, a lower housing and a slideable hinge module that connects the upper housing with the lower housing. The slideable hinge module is configured to allow the upper housing to slide along a straight line with the lower housing and to allow the upper housing to pivot relative to the lower housing. In one embodiment, the slideable hinge module is mounted to a display of a mobile phone to allow for sliding and pivoting of the display relative to the lower housing of the phone.

In accordance with another embodiment of the present invention, an electronic device includes an upper housing and a lower housing and a slideable hinge module that connects the upper housing with the lower housing. The slideable hinge module is configured to allow the upper housing to slide relative to the lower housing and to allow the upper housing to pivot away from the lower housing.

In accordance with another embodiment of the present invention, a slideable hinge is provided to slideably attaching a first member to a second member. The slideable hinge includes a traveling plate, a guide plate, and a c-channel configured to be moveably secured to the guide plate and slideably secured to the traveling plate a module.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE DRAWINGS

FIG. 1A is a front perspective view of an example of a slideable mobile communications device in a closed position in accordance with an embodiment of the present invention;

FIG. 1B is a perspective view of the slideable mobile communications device of FIG. 1A with the mobile communications device in an open position;

FIG. 2 is an exploded view of the slideable mobile communications device of FIG. 1B illustrating a slideable hinge module;

FIG. 3A is a front perspective view of the slideable hinge module in the open position of FIG. 2;

FIG. 3B is a front perspective view of the slideable hinge module of FIG. 2 in the closed position;

FIG. 4 is a rear side view of the lower housing the slideable hinge module of FIG. 3B;

FIG. 5 is a perspective view of the rear portion of the slideable hinge module of FIG. 3B;

FIG. 6 is a perspective view of the slideable hinge module of FIG. 3A with the top cover removed;

FIG. 7 is a perspective view of a portion of the slideable hinge module of FIG. 3A;

FIG. 8 is a back view of the slideable hinge module of FIG. 6;

FIG. 9 is a flow chart of a process for operating the slideable mobile communications device of FIG. 1A in accordance with an example embodiment of the present invention;

FIG. 10 is a front perspective view of the slideable hinge module of FIG. 3B with the top cover removed;

FIG. 11 is a front perspective view of a portion of the slideable hinge module in of FIG. 10;

FIG. 12A is a front cross-sectional perspective view of the slideable hinge module of FIG. 3B in the closed position;

FIG. 12B is a front cross-sectional perspective view of the slideable hinge module of FIG. 3A in the open position;

FIG. 13 is a perspective view of a portion of the slideable hinge module of FIG. 12B in the open position;

FIG. 14A is a side cross-sectional view of FIG. 12A in the closed position;

FIG. 14B is a side cross-sectional view of FIG. 12B in the open position;

FIG. 15A is a front perspective view of an example of a slideable mobile communications device in accordance with another embodiment of the present invention;

FIG. 15B is a perspective view of the slideable hinge of FIG. 15A with the slideable hinge in an open position;

FIG. 16A is a side view of the right side of FIG. 15A in the closed position;

FIG. 16B is a side view of the right side of FIG. 15B in the open position;

FIG. 17A is a cross-sectional view of FIG. 16A; and

FIG. 17B is a cross-sectional view of FIG. 16B.

### DETAILED DESCRIPTION OF EMBODIMENTS OF THE INVENTION

The following detailed description of embodiments refers to the accompanying drawings, which illustrate specific embodiments of the invention. Other embodiments having different structures and operations do not depart from the scope of the present invention.

Embodiments of the present invention may take the form of an entirely hardware embodiment that may be generally be referred to herein as a “module”, “device” or “system.”

Embodiments of the present invention are described below with reference to illustrations and/or flowchart of methods, apparatus (systems) and computer program products according to embodiments of the invention. It will be understood that each block of the flowchart illustrations and combinations of blocks in the flowchart illustrations, can be implemented manually by a person or automatically by computer program instructions, or a combination thereof. Any computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

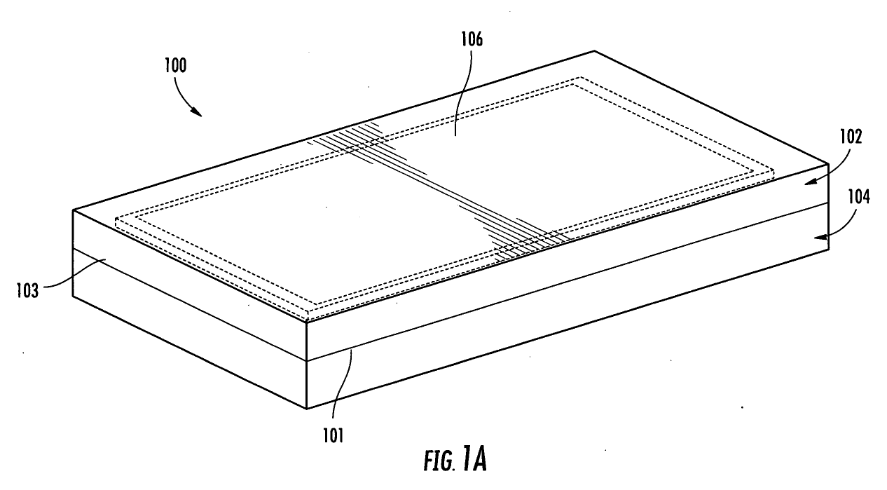

FIG. 1A is a front perspective view of an example of a slideable mobile communications device 100 in a closed position in accordance with an embodiment of the present invention. The mobile device 100 may be any mobile device, such as a cellular telephone, a personal digital assistant (PDA), a cordless telephone, a computing device, a portable game system, a portable audio system, a portable video system, etc. The mobile device 100 illustrated in FIG. 1A is for purposes of illustrating an embodiment of the present invention and embodiments of the present invention are not limited by this embodiment but include any embodiment within the scope of the present invention.

The mobile device 100 may include an upper housing 102 and a lower housing 104. In one embodiment, the upper housing 102 forms the front half of the mobile device 100 while the lower housing 104 forms the back half of the mobile device 100.

The lower housing 104 has a front face 101 and the upper housing 102 has a back face 103. When fully assembled, the back face 103 of upper housing 102 may be adjacent to the front face 101 of the lower housing 104. The front face 101 of the lower housing 104 may define a first plane (not shown) which may be substantially parallel to a second plane (not shown) defined by the back face 103 of the upper housing 102. The back face 103 of the upper housing 102 may be configured to slide within the second plane. In one embodiment, the front face surface 101 and/or back face surface 103 are substantially planar or flat so that each surface 101, 103 are defined by planes that are parallel to each other. In another embodiment, the front face 101 and the back face 103 mate in the closed position of FIG. 1A.

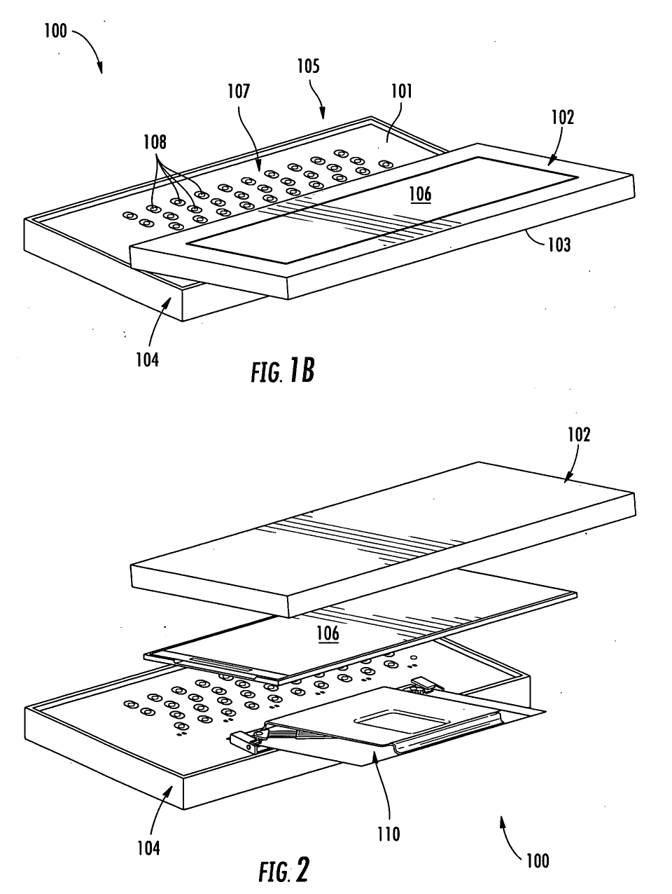

FIG. 1B is a perspective view of the slideable mobile communications device 100 of FIG. 1A with the mobile communications device 100 in an open position. As shown in FIGS. 1A and 1B, the upper housing 102 and the lower housing 104 are separate parts, connected or integrated together via a slideable hinge module to form the mobile device 100. The slideable hinge module is described later with reference to FIGS. 2-17.

The upper housing 102 of the mobile device 100 may include a user interface 105 to facilitate controlling operation of the communications device 100, including, for example, initiating and conducting phone calls, playing games, playing music, operating a camera, navigating the Internet, viewing images and/or text on a display 106, controlling other software or hardware operations, etc. The user interface 105 may include a display 106 to provide visual signals to a user as to the status and operations of the communications device 100. The display 106 may be a liquid crystal display (LCD), for example, capable of presenting images. The display 106 may provide information to a user or operator in the form of images, text, numerals, characters, graphic user interface (GUI) and the like. The user interface 105 may also include a keypad 107 which may include a series of keys 108. The keypad 107 may include function keys or buttons as wells as a point device, such as a trackball, joystick or the like, in order to permit the user to communicate commands through the mobile device 100, such as, for example, playing games, dialing phone numbers, initiating and terminating calls, establishing other communications and the like. The keypad 107 may also be used to control other operations of the mobile device 100, such as accessing the Internet, sending and receiving email and/or text messages, operating a camera, playing music, viewing video, etc.

The mobile device 100 may also include a microphone a speaker, and/or any other devices. Features of the user interface 105 other than those described herein may also be included in the user interface 105. It should be noted that one or more of the features of the user interface 105 may be integrated on the upper housing 102 of the mobile device 100 and/or one or more features of the user interface 105 may be integrated in the lower housing 104 of the mobile device 100.

FIG. 2 is an exploded view of the slideable mobile communications device 100 of FIG. 1B illustrating a slideable hinge or slideable hinge module 110. It should be noted that the slideable hinge 110 in FIG. 2 is in the open position. The slideable hinge 110 may be connected to the lower housing 104 and the display 106. A housing cover 112 may enclose the display and slideable hinge 110.

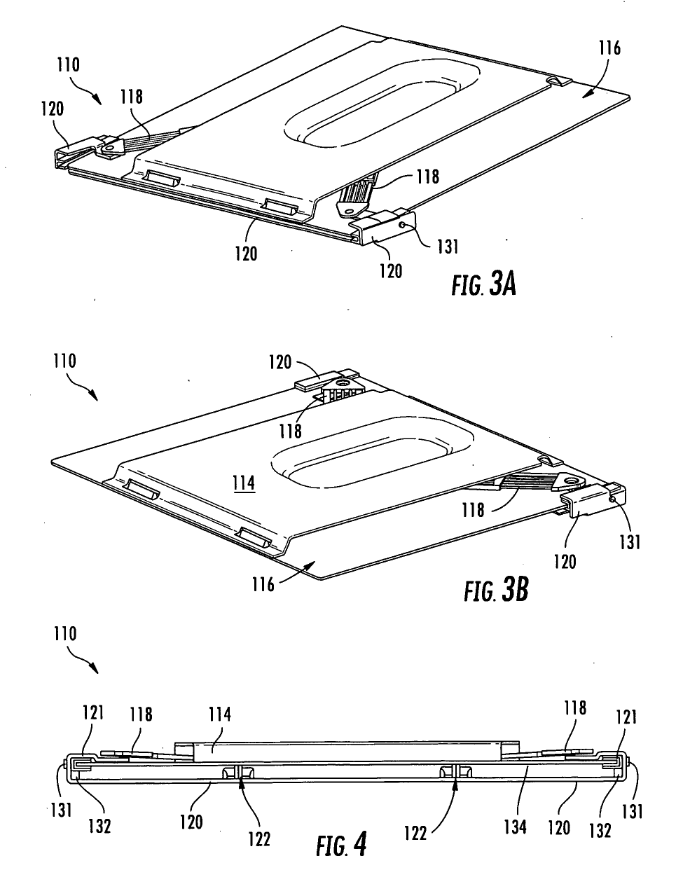

FIGS. 3-8 illustrate the slideable hinge 110 of FIG. 2. It should be noted that FIGS. 2-5 illustrate the slideable hinge 110 having a top cover plate 114 covering the slideable hinge 110; however, FIGS. 6 and 8 are illustrations with the top cover plate 114 removed.

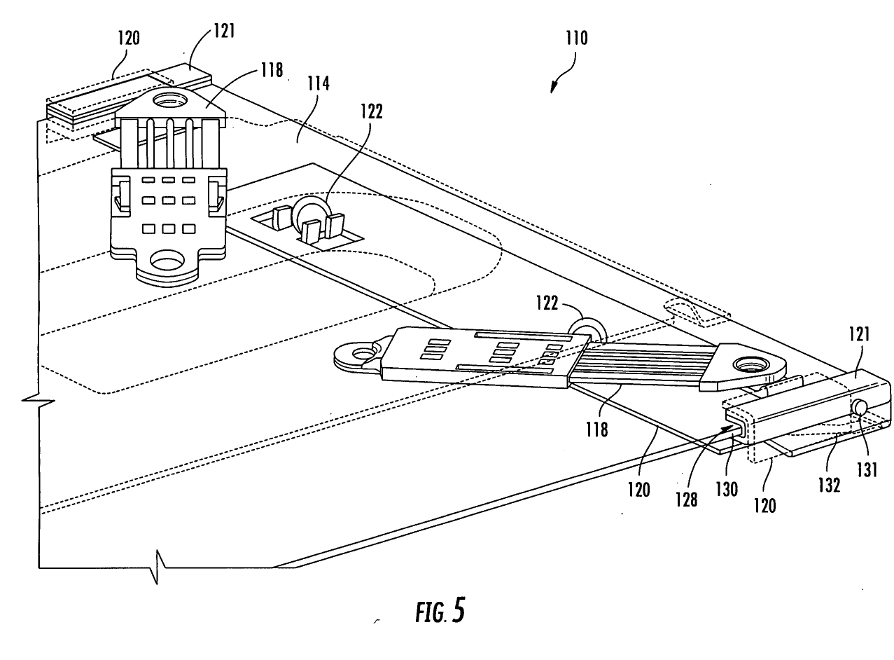

FIGS. 3A-3B are front perspective views of the slideable hinge module 110 of FIG. 2 in the open position and in the closed position, respectively. Notably, FIG. 4 is a rear side view of the lower housing the slideable hinge module of FIG. 3B; FIG. 5 is perspective view of the rear portion of the slideable hinge module of FIG. 3B; and FIG. 6 is a perspective view of the slideable hinge module of FIG. 3A with the top cover removed. The slideable hinge module 110 may include a traveling plate 116, at least one spring 118, a guide plate 120, a c-channel 121 and at least one rolling member (e.g., wheel, protruding member, etc.) 122. The guide plate 120 may be mounted (directly or indirectly) to the lower housing 104 or to devices of the lower housing 104. Similarly, the traveling plate 116 may be mounted (directly or indirectly) to the upper housing 102 or to devices of the upper housing 102.

The traveling plate 116 may be any device having a substantially planar surface 123. The traveling plate 116 has a first end 124 and a second end 126 and, in one embodiment, may include at least one dimple 128 at the first end 124 (FIGS. 6 and 8). The dimple 128 may be of any shape or size and may be configured to be an indention or depression in the planar surface 123 of the traveling plate 116. For example, the planar surface 123 may be aligned along a plane (not shown) and one or more dimples 128 in the traveling plate may be disposed so that one or more portions of the traveling plate 116 are not aligned along such plane. One or more dimples 128 may be positioned on the traveling plate 116 so as to receive the at least one rolling member 122 to allow the traveling plate 116 to pivot relative to the lower housing 104 causing the slideable hinge 110 to be in the open position. In one embodiment, all rolling members 122 are in the dimples 128 in the open position and at least one rolling member 122 is not within the dimples 128 in the closed position.

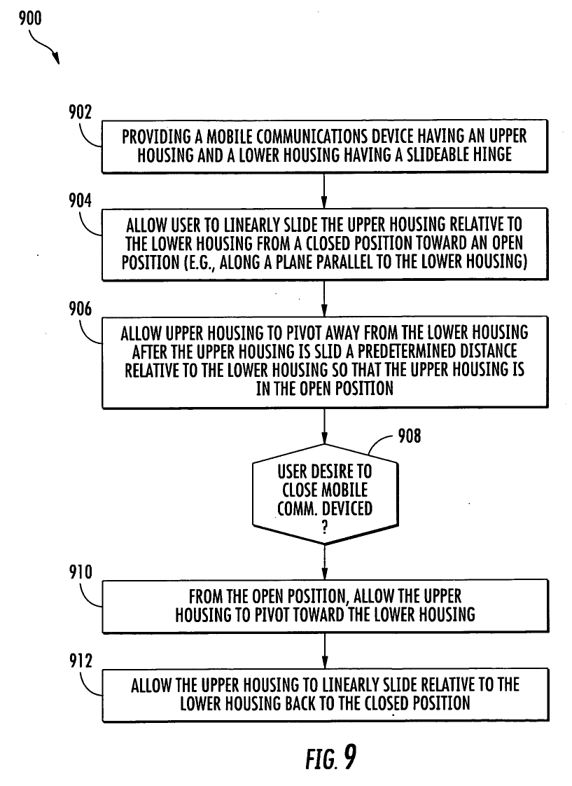

The springs 118 may be connected between the guide plate 120 and the traveling plate 116 and thus, assert forces to move the upper housing 102 relative to the lower housing 104. Any type of springs 118 may be employed. For example, the springs 118 may be compression springs. As such, the compression springs 118 become compressed when the guide plate 120 is moved toward the center of the traveling plate 116 and thus, exert a force on the guide plate 120 toward the end 124, 126 of the traveling plate that the guide plate 120 is closest to. The operation of the springs 118 and the slideable hinge 110 is discussed in more depth later with regard to FIGS. 9-17.

The guide plate 120 may be a device which guides linear movement of the traveling plate 116 relative to the lower housing 104. The guide plate is best illustrated in FIGS. 5-6 and in FIG. 8, which is a back view of the slideable hinge module of FIG. 6. For example, the guide plate, as illustrated, may be a plate (or other device) extending about the width of the traveling plate 116. Such guide plate 120 slides along the length of the traveling plate 116 from the second end 126 of the traveling plate 116 when the slideable hinge 110 is in the closed position (FIGS. 6 and 8) to the first end 124 of the traveling plate 116 causing the slideable hinge 110 to be in the open position (FIG. 3A). In order to facilitate such movement of the traveling plate 116, the c-channel 121 is attached to the guide plate 120 and slides along the traveling plate edges, as described immediately below.

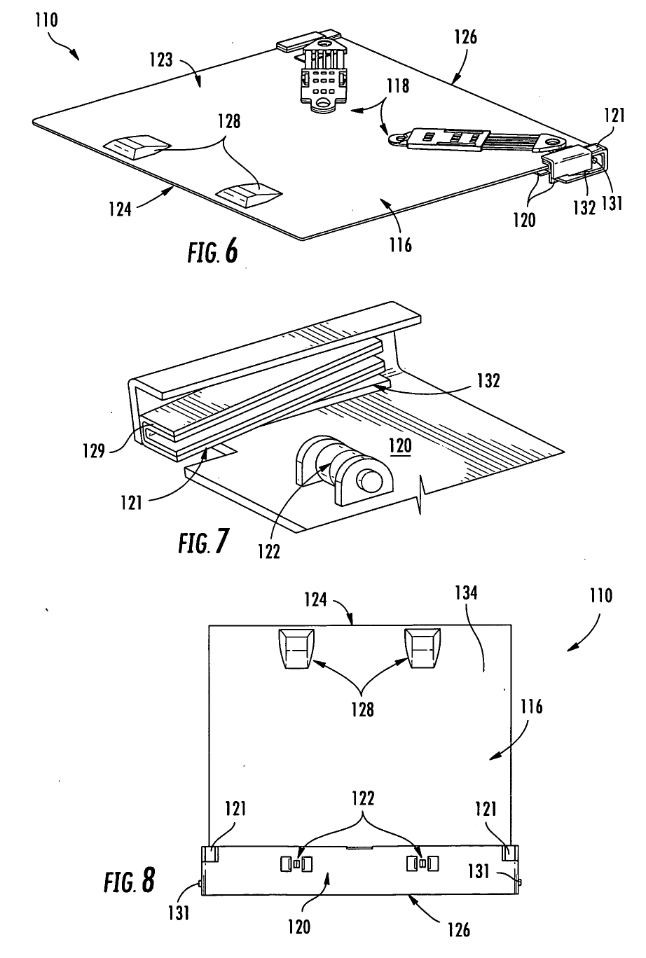

The c-channel 121 is best illustrated in FIGS. 5 and 7. FIG. 7 is a perspective view of a portion of the slideable hinge module of FIG. 3A, namely the guide plate 120 with the c-channel 121. The c-channel 121 is pivotably secured to the guide plate 120 about a pivot point 131. The c-channel 121 may be shaped in the letter “C” and may have a portion 129 to receive a side edge 130 of the traveling plate 116. The c-channel 121 may make contact with the traveling plate 116 to smoothly guide the traveling plate 116 while the guide plate 120 slides along the traveling plate 116. Thus, the c-channel 121 smoothly slides along the traveling plate edge 130 when the traveling plate 116 moves relative to the guide plate 120. It should be noted that two c-channels 121 are illustrated in FIG. 5 as slideably attached to opposing side edges of the traveling plate 116 and to the guide plate 120 so as to be able to slideably hold the traveling plate 116.

Each c-channel 121 may have a pivot point 131 attached to the guide plate 120. Additionally, each c-channel 121 may be held to the guide plate by a spring, such as a leaf spring 132. One side of the leaf spring 132 may be attached to the guide plate 120 while the other end of the leaf spring 132 is attached to the c-channel 121. With such configuration, the leaf spring may assert a constant downward force towards the guide plate 120 on one side of the c-channel 121 so that when resistance is mitigated (e.g., when the wheel 122 enters the dimple 128), the c-channel 121 (and thus, the traveling plate 116 and associated upper housing 102) rotates or pivots relative to the lower housing 104. Operation of the c-channel 121, guide plate 120 and traveling plate 116 are discussed in more depth later with regard to FIGS. 9-17.

At least one rolling member 122 may be connected to the guide plate 120 to facilitate movement of the traveling plate 116 relative to the guide plate 120. The rolling member 122 may be a wheel, roller, a protruding member (e.g., a protrusion from the guide plate toward the traveling plate 116), and the like. One or more rolling members 122 may be employed. For example, as illustrated best in FIGS. 4, 5 and 8, two rolling members 122 may be employed. The rolling member 122 may be disposed between the guide plate 120 or other surface to contact the bottom surface 134 of the traveling plate 116. The constant downward force asserted by the leaf spring 132 to the traveling plate 116 allows the rolling members 122 to be in continuous and constant contact with the traveling plate bottom surface 134. The rolling member 122 may be configured and positioned on the traveling plate 116 so as to be received in the dimple 128 putting the slideable hinge 110 in the open position, as will be later described.

FIG. 9 is a flow chart of a process 900 for operating the slideable mobile communications device of FIG. 1A in accordance with an example embodiment of the present invention. In block 902, a mobile communications device 100, as described herein, is provided having an upper housing and a lower housing slideably hinged together. In block 904, from a closed position, if the user desires to open the upper and lower housings of the mobile communications device the upper housing may linearly slide relative to the lower housing. The closed and open positions are exemplified in FIGS. 1A and 1B, respectively. Detailed operations, including the sliding of the upper and lower housings relative to each other, are discussed later with respect to FIGS. 10-17. In block 906, after the upper housing is slid relative to the lower portion a predetermined distance, the upper portion pivots relative to the lower portion. This allows the display of the mobile communications device to be angled toward the user. After opening the mobile communications device, if the user desires to close the upper and lower housings of the mobile communications device (block 908), the upper housing may be pivoted or rotated toward the lower housing (block 910) and the upper housing is slid relative to the lower portion back to the closed position (block 912). FIGS. 10-17 further illustrate this method 900 according to various embodiments.

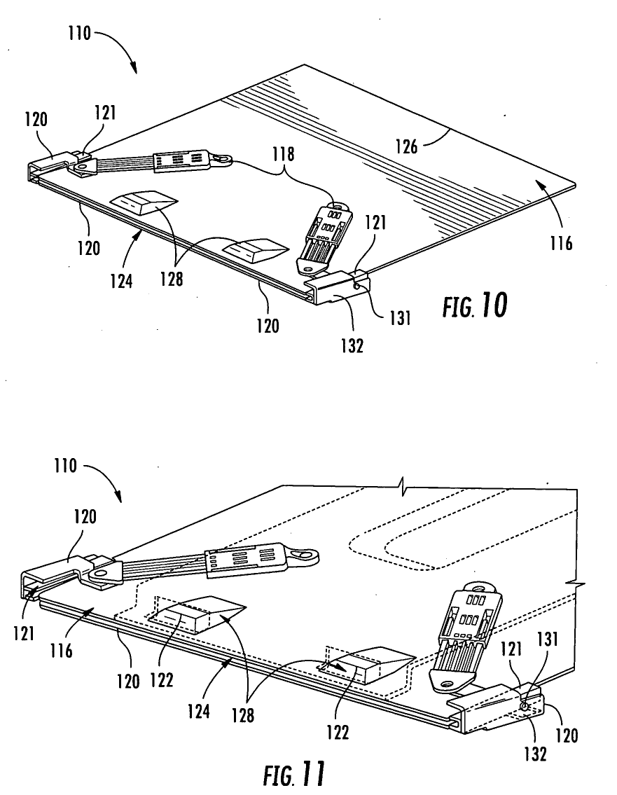

FIGS. 10-11 are front perspective views of the slideable hinge module of FIG. 3B with the top cover removed and with the top cover in place, respectively. In FIGS. 10-11, slideable hinge 110 is in the open position due to the wheels 122 being pulled and received into the dimples 128 by the leaf spring 132. As such, the leaf spring 132 causes the c-channel 121 to rotate about the pivot point 131 and thus, pulling the first end 124 of the traveling plate 116 toward the guide plate 120. This causes the traveling plate 116 to rotate relative to the guide plate 120 and since the guide plate 120 is mounted to the lower housing 104, the traveling plate 116 also pivots or rotates relative to the lower housing 104.

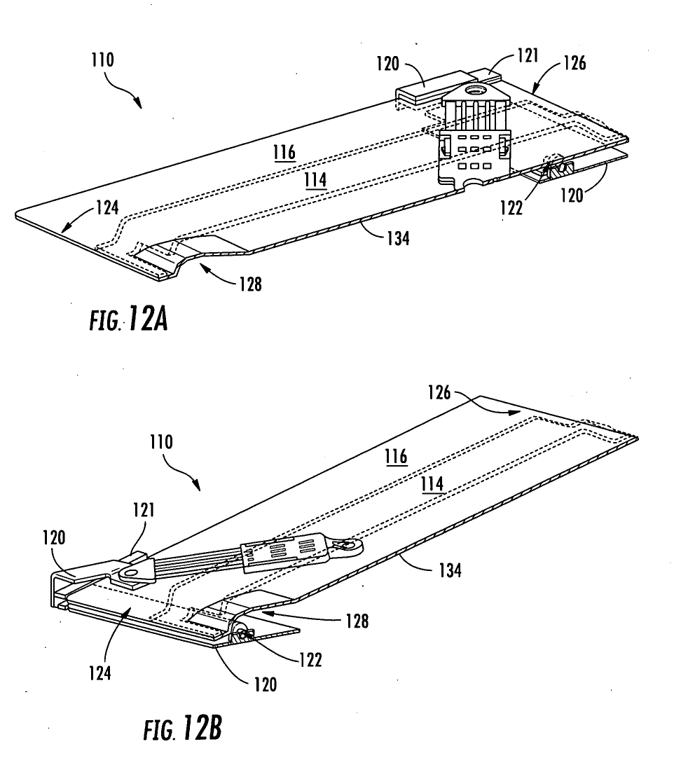

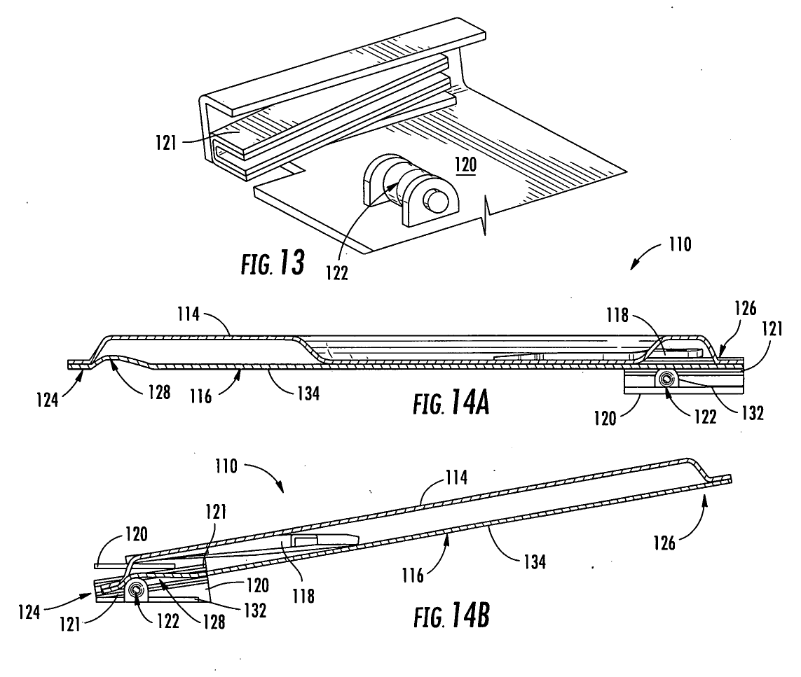

FIGS. 12A-12B are front cross-sectional perspective views of the slideable hinge module of FIGS. 3B and 3A in the closed and open position, respectively. FIGS. 14A-14B are side cross-sectional views of FIGS. 12A-12B in the closed and open position, respectively. As illustrated in FIGS. 12A and 14A, the guide plate 120 is disposed at the second end 126 of the traveling plate 116 and thus, the slideable hinge 110 is in the closed position. The wheels 122 are disposed against the bottom surface 134 of the traveling plate 116. Because the wheels 122 are disposed in the plane defined by the traveling plate 116 and not within the dimples 128, the traveling plate 116 may be held substantially parallel to the lower housing 104 and the guide plate 120. This allows the upper housing 102 to be linearly slid along a straight line relative to the lower housing 104. The upper housing 102 may be slid linearly a predetermined distance relative to the lower housing 104. The sliding of the upper housing 102 causes the slideable hinge 110 to be moved away from the closed position towards an open position, which is illustrated in FIGS. 12B and 14B.

In moving the slideable hinge 110 from the closed position (FIGS. 12A and 14A) to the open position (FIGS. 12B and 14B), the guide plate 120 is moved from the second end 126 to the first end 124 of the traveling plate 116. In doing so, the wheels 122 roll from the second end 126 into the dimples 128 at the first end 124. This causes the leaf spring 132 to assert a downward force towards the guide plate 120 on the c-channel 121 thus rotating the c-channel 121 about the pivot point 131. Accordingly, the c-channel 121 rotates the traveling plate 116 relative to the guide plate 120 about pivot point 131, as illustrated in FIG. 13. Thus, the slideable hinge 100 is in the open position, which causes the display 106 or other device to be angled toward the operator of the device 100.

The mobile communications device 100, may be moved from the open position to the closed position by reversing the above actions. For example, the upper housing 102 may be pivoted about pivot point 131 to be aligned substantially parallel to the lower housing 104 and the upper housing 102 may be slid along a straight line from the first end 124 to the second end 126 of the traveling plate 116 to move back to the closed position.

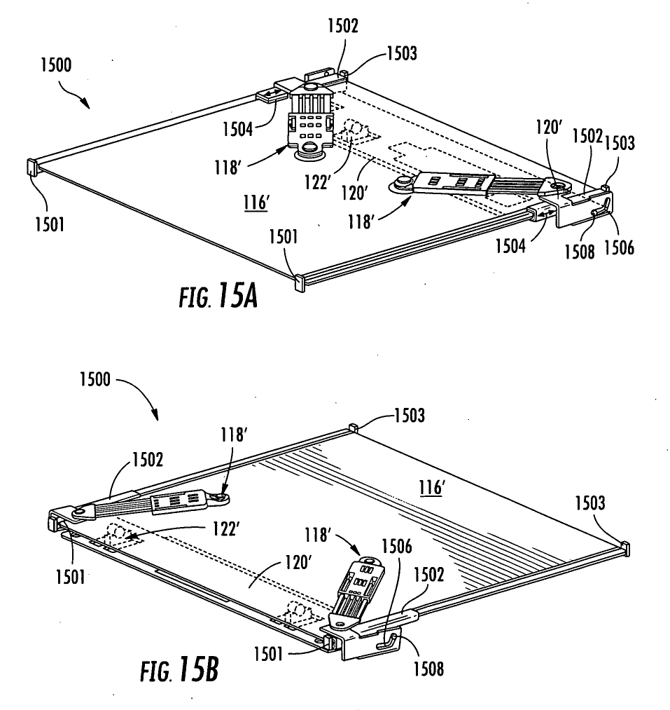

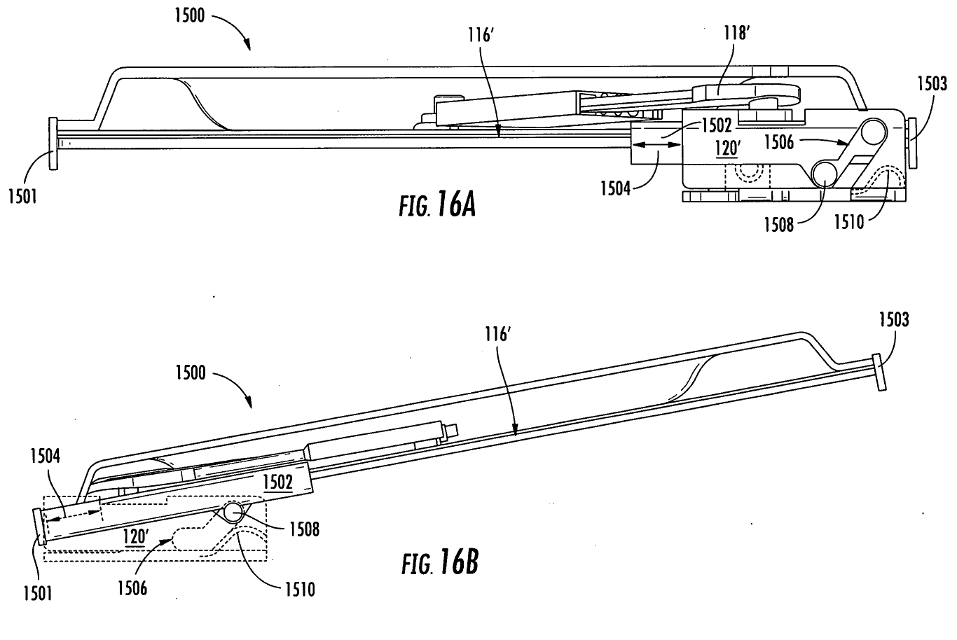

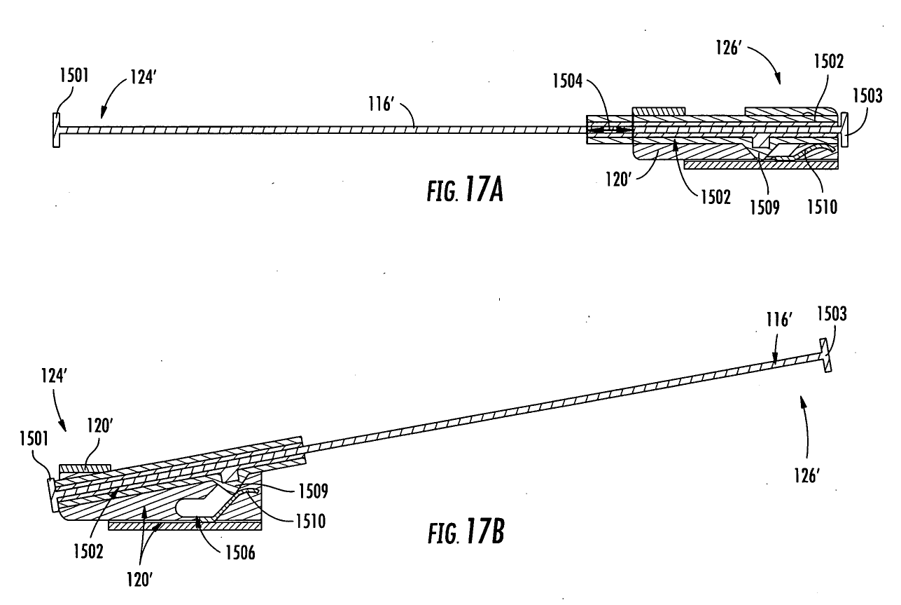

FIGS. 15-17 illustrate another exemplary slideable mobile communications device in accordance with another embodiment of the present invention. Specifically, FIGS. 15A-15B are front perspective views of the slideable hinge 1500 in the closed and open position, respectively; FIGS. 16A-16B are side views of the right side 1502 of the slideable hinge 1500 of FIGS. 15A-15B in the closed and open position, respectively; and FIGS. 17A-17B are cross-sectional views of FIG. 16A-16B, respectively.

The slideable hinge 1500 illustrated in FIGS. 15-17 is similar to the slideable hinge 110 of FIGS. 1-8. For example, the traveling plate 116′, springs 118′, guide plate 120′ (shown under traveling plate 116′), and rolling member (wheel) 122′ (shown under traveling plate 116′) of slideable hinge 1500 are similar in design and operation to those corresponding elements of the slideable hinge 110 described above. However, the traveling plate 116′ includes a front stopper 1501 at the front portion 124′ of the traveling plate 116′ and a back stopper 1503 at the back portion 126′ of the traveling plate 116′. The traveling plate 116′ also may not include any dimples 128. Additionally, the guide plate 120′ has a cam track 1506 on each of the opposing ends of the guide plate 120′. Operation of these elements is described in more depth below.

The slideable hinge 1500 of FIGS. 15-17 has a c-channel 1502 which extends a predetermined length 1504 toward the front portion 124′. As the guide plate 120′ is slid from the back portion 126′ to the front portion 124′ of the traveling plate 116′, the extending length portion 1504 of the c-channel 1502 stops at the front stopper 1501 and the guide plate 120′ continues toward the front end 124′ (over the c-channel 1502) until the guide plate 120′ also hits the front stopper 1501. When this happens, a cam 1508 of the c-channel 1502 is forced in the cam track 1506 of the c-channel by the spring 118′ and a leaf spring 1510 (FIGS. 17A-B). The leaf spring 1510 operates to assert a vertical force on the c-channel 1502 while the spring 118′ operates to provide a horizontal force upon the c-channel 1502. The c-channel 1502 may include a protrusion 1509 to assist in guiding the c-channel 1502 onto the leaf spring 1510 and thus to assist the cam 1508 along the cam track 1506. Nonetheless, by the cam 1508 being forced into the cam track 1506, the c-channel 1502 is rotated relative to the guide plate 120′. This rotates the upper housing 102 relative to the lower housing since the traveling plate 116′ is slideably connected to the c-channel 1502 and the upper housing 102 and the guide plate 120′ is connected to the lower housing 104.

The traveling plate 116′ may be mounted to a display 106 or other device in the upper housing 102. As such, the upper housing 102 is allowed to be slid along a straight line until the c-channel extension 1504 is compressed and the spring 118′ and leaf spring 1510 pulls the c-channel 1502 through the cam track 1506 via the cam 1508 of the c-channel. At that point, the upper housing 102 is rotated or pivoted relative to the guide plate 120′ and lower housing 104. The design of the cam track 1506 indicates the angle of rotation of the upper housing 102 relative to the lower housing. Any shape or configuration of the cam track 1506 may be employed.

After the cam 1502 is guided into the cam track 1506, the upper housing 102 is rotated relative to the lower housing 104 as previously mentioned, and thus, the slideable hinge 1500 is in the open position. The slideable hinge 1500 may be mounted to a display 106 and thus, when the slideable hinge 1500 is in the open position, the display is angled a predetermined angle toward the operator. If the operator wishes to close the device, the slideable hinge 1500 is moved into the closed position by reversing the above steps. For example, the operator may move the upper housing 102 such that the cam 1508 is moved back down the cam track 1506 and thus, pivoting or rotating the upper housing 102 relative to the lower housing 104 so that the upper housing 102 is aligned substantially parallel to the lower housing 104. The upper housing 102 may be slid along a straight line from the first end 124′ to the second end 126′ of the traveling plate 116′ to move the slideable hinge 1500 back to the closed position.

The flowchart and illustrations in the Figures illustrate the architecture, functionality, and operation of possible implementations of systems and methods according to various embodiments of the present invention. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by a human or special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A mobile device comprising:
an upper housing;
a lower housing; and
a slideable hinge module that connects the upper housing with the lower housing, the slideable hinge module being configured to allow the upper housing to slide along a straight line with the lower housing and to allow the upper housing to pivot relative to the lower housing.

2. The mobile device of claim 1, wherein the upper portion comprises a display attached to the slideable hinge module.

3. The mobile device of claim 1, wherein the straight line is parallel to a plane defined by the lower housing.

4. The mobile device of claim 1, wherein the slideable hinge module further comprises at least one spring coupled between the upper housing and lower housing to facilitate the sliding of the upper housing relative to the lower housing.

5. The mobile device of claim 1, wherein the slideable hinge module further comprises a guide plate and a traveling plate, the guide plate connecting with the lower housing and the traveling plate connectable with the upper housing.

6. The mobile device of claim 5, wherein the slidable hinge module further comprises:
at least one protruding member on the guide plate; and
at least one dimple in the traveling plate positioned so as to receive the at least one protruding member.

7. The mobile device of claim 6, wherein the traveling plate comprises a first end and a second end, the at least one dimple being located at the first end, wherein the at least one protruding member being located at the second end at a closed position, and wherein the at least one protruding member being located in the dimple at the first end at an open position and thus, allowing the traveling plate to pivot relative to the lower position.

8. The mobile device of claim 7, wherein the at least one protruding member comprises at least one rolling member to facilitate movement of the guide plate relative to the traveling plate.

9. The mobile device of claim 5, wherein the sliding module further comprises:
at least one c-channel member moveably connected with the guide plate, the c-channel member configured to guide movement of the traveling plate; and
at least one spring to facilitate the pivoting of the upper housing relative to the lower housing.

10. The mobile device of claim 1, wherein the sliding module further comprises at least one spring to facilitate the pivoting of the upper housing relative to the lower housing.

11. The mobile device of claim 5, wherein the traveling plate is mounted to a display.

12. The mobile device of claim 1, wherein the lower housing comprises a top face and the upper housing having a bottom face, the top face and bottom face mating together in a closed position, the top face being substantially planar.

13. An electronic device having an upper housing and a lower housing, the electronic device comprising:
a slideable hinge that connects the upper housing with the lower housing, the slideable hinge being configured to allow the upper housing to slide relative to the lower housing and to allow the upper housing to pivot away from the lower housing.

14. The electronic device of claim 13, wherein the slideable hinge further comprises a guide member secured to the lower housing and at least one spring disposed between the guide member and a traveling plate connected with the guide member to pivot the traveling plate relative to the lower housing.

15. The electronic device of claim 14, wherein the slideable hinge comprises at least one rolling member attached to the guide plate and making contact with a surface of a traveling plate connected with the guide plate, and wherein the traveling plate is aligned along a plane and defines at least one dimple in the traveling plate, the at least one dimple being positioned to receive the at least one rolling member in an open position to allow the traveling plate to pivot relative to the lower housing.

16. The electronic device of claim 14, wherein the slideable hinge comprises a c-channel device slideably connected to the traveling plate and rotatably connected to the guide plate to allow the traveling plate to rotate relative to the lower housing.

17. A slideable hinge for slideably attaching a first member to a second member, the slideable hinge comprising:
a traveling plate;
a guide plate; and
a c-channel configured to be moveably secured to the guide plate and slideably secured to the traveling plate a module.

18. The slideable hinge of claim 17, further comprising at least one protrusion, wherein the traveling plate comprises at least one dimple to receive the at least one protrusion to rotate the first member relative to the second member.

19. The slideable hinge of claim 17, wherein the c-channel comprises at least one cam and the guide plate comprises a cam track to guide the at least one cam, the first member being rotatable when the cam is guided from one position in the cam track to another position in the cam track.

20. The slideable hinge of claim 17, wherein the traveling plate has a first end and a second end, the guide plate being slideable from the first end to the second end of the traveling plate and the c-channel is rotatable within the c-channel when the guide plate is slid to the second end of the traveling plate.
